(19) United States
(12) Patent Application Publication
(10) Pub. No.: US 2010/0289656 A1
(43) Pub. Date: Nov. 18, 2010

(54) NETWORK DEVICE

(75) Inventors: Masanori FUJIOKA, Nagoya (JP); Masao YAMAGUCHI, Nagoya (JP); Akira ONO, Nagoya (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/778,476

(22) Filed: May 12, 2010

(30) Foreign Application Priority Data
May 13, 2009 (JP) 2009-116177

(51) Int. Cl. G08B 21/00

(52) U.S. Cl. 340/644

(57) ABSTRACT

A network device is provided which comprises a lamp display that includes a lamp visible from the outside, and that has a display mode in which the lamp may light up when the network device is powered on, and a non-display mode in which the lamp does not light up when the network device is powered on; and a lamp mode setting module to set the lamp display to the display mode or the non-display mode, wherein when a prescribed condition requiring the user to take note of the lamp is not met within a prescribed time interval in the display mode, the lamp mode setting module sets the lamp display to the non-display mode, and when the prescribed condition is met in the non-display mode, the lamp mode setting module sets the lamp display to the display mode.

### CROSS-REFERENCE TO RELATED APPLICATIONS

The present application claims relates the priority based on Japanese Patent Application No. 2009-116177, filed on May 13, 2009, the disclosure of which is incorporated by reference in its entirety.

### BACKGROUND OF THE INVENTION

1. Field of the Invention

The present invention relates to a network device to connect an electronic device to a network.

2. Description of the Related Art

A wireless LAN access point is one example of known network devices for connecting an electronic device to a network. Conventionally, an access point is provided with several lamps that are observable externally (see, for example, JP2005-175524A). These lamps have the function of flashing or lighting to inform the user of information such as wireless LAN connection status and communication status. In other words, the user can verify the connection status and communication status of the wireless LAN by observing that the lamps are lighting or flashing. Hereinafter, “lighting or flashing” is also denoted as “lighting/flashing”.

However, these lamps are lighting/flashing continuously while the access point is being powered. Thus, the lamps are lighting/flashing continuously even when there is no need to inform the user, and, as a result, energy is consumed unnecessarily. Moreover, when the lighting/flashing lamps happen to intrude into the field of view of the user while the user is watching television for example, the user may perceive this as an annoying distraction. Likewise, when the lamps are lighting/flashing in a darkened room, the user may perceive an annoying distraction. This problem is not limited to access points, but common to network devices furnished with a lamp that is externally observed.

### SUMMARY

Accordingly, the present invention is directed to a network device furnished with lamps or indication lights that are externally observable. A first object of the present invention is to reduce the power consumed by the indication light (also termed “lamp”) when they are continuously or intermittently energized, while nevertheless maintaining functionality of the indication light. A second object of the present invention is to provide a technique for reducing the extent to which the user is annoyed by the continuously lit or flashing light.

The present invention has been made to attain the above objects at least in part according to the following modes or embodiments of the invention.

### First Example of Application

According to a first example of application of the present invention, there is provided a network device adapted to connect an electronic device to a network comprising:

a lamp display that includes a lamp visible from the outside, and that has a display mode in which the lamp may light up when the network device is powered on, and a non-display mode in which the lamp does not light up when the network device is powered on; and

a lamp mode setting module that selects one of the display mode and the non-display mode,

wherein when a prescribed condition requiring the user to take note of the lamp is not met within a prescribed time interval in the display mode, the lamp mode setting module sets the lamp display to the non-display mode, and

when the prescribed condition is met in the non-display mode, the lamp mode setting module sets the lamp display to the display mode.

According to the network device of the first example of application, while the lamp display is in the display mode, it goes into non-display mode unless a prescribed condition is met, thereby reducing power consumption associated with lighting/flashing of the lamp. Additionally, with the lamp display in the display mode, when the prescribed condition that requires the user to monitor the lamp is not met, the lamp display switches to the non-display mode, thereby minimizing the distraction of the user. With the lamp display in the non-display mode, when a prescribed condition is met, the lamp display switches to the display mode, thereby enabling the user to verify a connection status and a communication status of the LAN through lighting/flashing of the lamp. In other words, the function of the lamp can be maintained. Hereinafter, the display mode and the non-display mode are collectively referred to as “lamp modes”.

### Second Example of Application

According to a second example of application of the present invention, there is provided the network device according to the first example of application described above, wherein the prescribed condition includes at least in part a condition that the user performed a prescribed operation on the network device.

According to the network device of the second example of application, when the user performed a prescribed operation on the network device, it is inferred that the need has arisen for the user to verify connection status and communication status of the LAN, and therefore the lamp display is set to the display mode. The user can thus verify connection status and communication status of the LAN through lighting/flashing of the lamp. Additionally, when a prescribed operation is not performed, the lamp display is set to the non-display mode, thereby minimizing power consumption associated with lighting/flashing of the lamp. That the prescribed condition includes at least in part a condition that the user performed a prescribed operation on the network device, should be interpreted in the following two ways. In one way, the prescribed condition includes plural conditions, one of which is that the user has performed a prescribed operation on the network device (this condition is hereafter referred to as “Condition A”). And in the other way, let there be other conditions such as, for example, Conditions B, C and D. Then, one or more of Conditions A through D are specified as the prescribed condition. Hereinafter, comparable expressions shall be understood to have comparable meaning.

### Third Example of Application

According to a third example of application of the present invention, there is provided the network device according to the second example of application described above, wherein the prescribed operation is that the user activates a settings screen of the network device.

According to the network device of the third example of application, when the user activated the settings screen of the network device, it is inferred that the user may need to check the connection status or communication status of the LAN. In this case, the lamp display is set to the display mode, thereby enabling the user to check the connection status and communication status of the LAN through lighting/flashing of the lamp, for a prescribed time interval.

### Fourth Example of Application

According to a fourth example of application of the present invention, there is provided the network device according to the second example of application described above, further comprising:

a switch to change various settings of the network device,

wherein the prescribed operation is for the user to change over the switch.

According to the network device of the fourth example of application, when the user changed over the switch, it is inferred that the user may need to check the connection status or communication status of the LAN. In this case, the lamp display is set to the display mode, thereby enabling the user to check the connection status and communication status of the LAN through lighting/flashing of the lamp, for a prescribed time interval.

### Fifth Example of Application

According to a fifth example of application of the present invention, there is provided the network device according to the first example of application described above, wherein the prescribed condition includes at least in part a condition that connection status of the electronic device to the network has been changed.

According to the network device of the fifth example of application, when a change occurred in at least the connection status of an electronic device to the network, it is inferred that the user may need to check the connection status or communication status of the LAN, and therefore the lamp display is set to the display mode. The user can thus observe the connection status and communication status of the LAN through lighting/flashing of the lamp. Moreover, when there is no change in the connection status of electronic devices, the lamp display is set to the non-display mode, thereby reducing power consumption associated with lighting/flashing of the lamp.

### Sixth Example of Application

According to a sixth example of application of the present invention, there is provided the network device according to the fifth example of application described above, wherein the change in connection status of the electronic device to the network is an increase or decrease of link pulses received by the network device.

According to the network device of the sixth example of application, when link pulses received by the network device increase or decrease in number, it is inferred that the user may need to check the connection status or communication status of the LAN. In this case, the lamp display is set to the display mode, thereby enabling the user to check the connection status and communication status of the LAN through lighting/flashing of the lamp, for a prescribed time interval.

### Seventh Example of Application

According to a seventh example of application of the present invention, there is provided the network device according to the first example of application described above, further comprising:

an anomaly detector to detect an anomaly in the network or the network device,

wherein the prescribed condition includes at least in part a condition that the anomaly detector has detected the anomaly.

According to the network device of the seventh example of application, when an anomaly is detected by the anomaly detector, it is inferred that the user may need to check the connection status or communication status of the LAN, and the lamp display is set to the display mode. Thus, the user can check the connection status and communication status of the LAN. If no anomaly is detected by the anomaly detector, the lamp display is set to the non-display mode, thereby reducing power consumption associated with lighting/flashing of the lamp.

### Eighth Example of Application

According to an eighth example of application of the present invention, there is provided the network device according to one of the first through seventh examples of application described above, further comprising:

an illuminance sensor to sense ambient illuminance around the network device; and

a brightness setting module to set brightness of the lamp,

wherein in a first instance in which the illuminance sensor senses high illuminance, the brightness setting module establishes a high brightness level when the lamp lights, and wherein in a second instance in which the illuminance sensor senses illuminance lower than in the first instance, the brightness setting module establishes a lower brightness level lower than in the first instance when the lamp lights.

According to the network device of the eighth example of application, when the lamp lights, in the first instance in which high illuminance is sensed by an illuminance sensor, lamp brightness is increased; or when the lamp lights in the second instance in which illuminance is lower than in the first instance, lamp brightness is decreased, so that power consumption by the lamp can be reduced further. The illuminance sensed by the illuminance sensor is also termed “ambient illuminance”.

The present invention may be embodied in any of various modes such as, for example, a network device, a method of controlling the network device, or a network system having the network device.

These and other objects, features, aspects, and advantages of the present invention will become more apparent from the following detailed description of the embodiments with the accompanying drawings.

### BRIEF DESCRIPTION OF THE DRAWINGS

FIG. 1 is an illustration depicting a mode of a network employing a network device 30 according to a first embodiment of the present invention;

FIG. 2 is a block diagram depicting the internal configuration of the network device;

FIG. 3 is a flowchart depicting the operation setup of the lamp display 350 of the first embodiment;

FIG. 4 is a table listing the prescribed condition subjected to the decision made by the prescribed condition decision module 341;

FIG. 5 is an illustration depicting a mode of a network employing network devices 30a, 40 according to a second embodiment of the present invention; and

FIG. 6 is a block diagram depicting the internal configuration of the wireless LAN terminal 40.

### DETAILED DESCRIPTION OF THE EMBODIMENT

Now, modes of practicing the present invention will be described in the following order named:

A. First Embodiment

B. Second Embodiment

C. Modified Embodiment

### A. First Embodiment

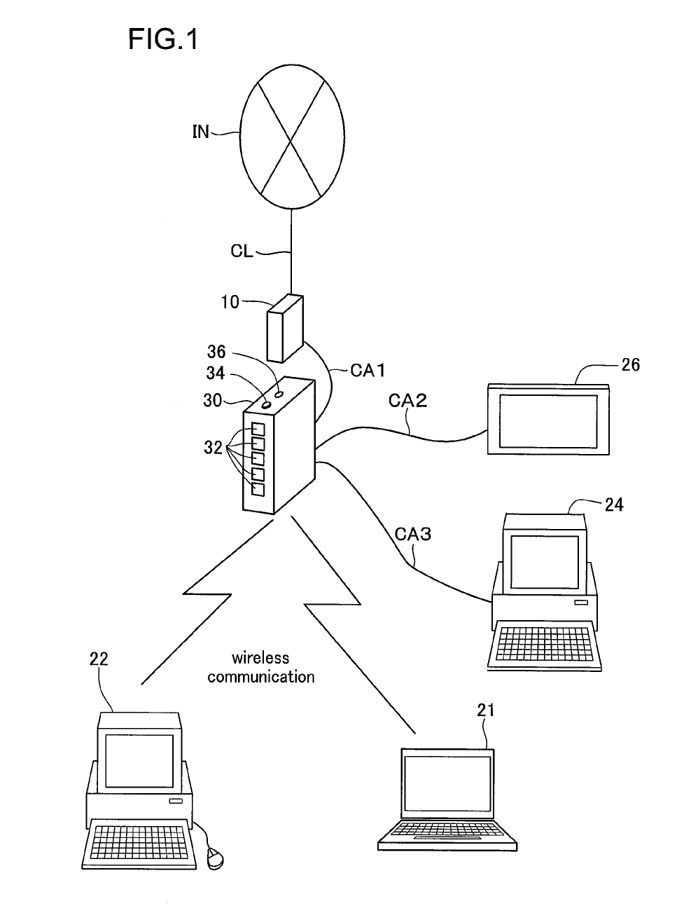

FIG. 1 is an illustration depicting a mode of a network employing a network device 30 according to a first embodiment of the present invention. The network device 30 has the function of a wireless LAN access point, a hub and a router for connecting a LAN (Local Area Network) to a WAN (Wide Area Network). The network device 30 having these sorts of functions is also termed a broadband router. Herein, the mode in which the network device 30 functions as an access point is termed “bridge mode”; and the mode in which it functions as a router is termed “router mode”. In addition to the bridge mode and the router mode, the network device 30 of the present embodiment has an “auto mode” in which the bridge mode or the router mode is selected appropriately according to the communication conditions of the network by the user. The bridge mode, router mode, and auto mode are referred to collectively as the “network modes”.

A modem 10 is connected by a cable CA1 to the WAN port of the network device 30, and the modem 10 connects through a communication line CL to servers etc. on the Internet IN. Various electronic devices (also called terminals) 21, 22, 24, 26 that make up the LAN can access servers on the Internet IN through the network device 30. The router function of the network device 30 is not limited to its Internet connectivity, but may include its connectivity to other wide area networks or LANs. Here, computers 21, 22, 24 and a television 26 serve as electronic devices.

The network device 30 establishes a LAN with the computers 21, 22 through wireless communication, and establishes a LAN with the computer 24 and the television 26 through wired communication using cables CA2, CA3. The electronic devices (also called terminals) 21, 22, 24, 26 are interconnected through the network device 30.

The network device 30 is equipped with a plurality of displays 32 that house a plurality of display lamps which are visible from the outside when lighting/flashing; a switch (SW) 34 for changing the various settings of the network device 30; an illuminance sensor 36 for sensing ambient illuminace around the network device 30; and several connection ports (not shown) for connecting the cables CA1, CA2, CA3. LEDs are used as the display lamps.

Through independent lighting/flashing of these display lamps, these display lamps may inform the user of its connection to the network, the conditions of the networks, and the conditions of the network device 30, as well as the changes in these conditions. As specific examples, the display lamps may light/flash to inform the user of the changes in the conditions of connecting the various terminals to the network; the anomalies occurring on the network; the anomalies occurring in the network device 30; the communication conditions of the terminals; the network mode of the network device 30 or change of the network mode; the presence of a settings mode for making security settings such as wireless LAN encryption method or encryption key etc.; and whether the network device 30 is active; as well as whether the cables CA1, CA2, CA3 are properly connected to the wired LAN ports and WAN port respectively. Herein, the connection conditions to the network, the conditions of the network, the network device conditions, and the changes in these conditions are also referred to collectively as “network operational status”.

As the switch 34 for changing the various settings of the network device 30 there may be employed, for example, a switch for performing security settings for the wireless LAN; a switch for changing over the network mode of the network device 30; or a reset switch for restoring the various settings of the network device 30 to their initial settings.

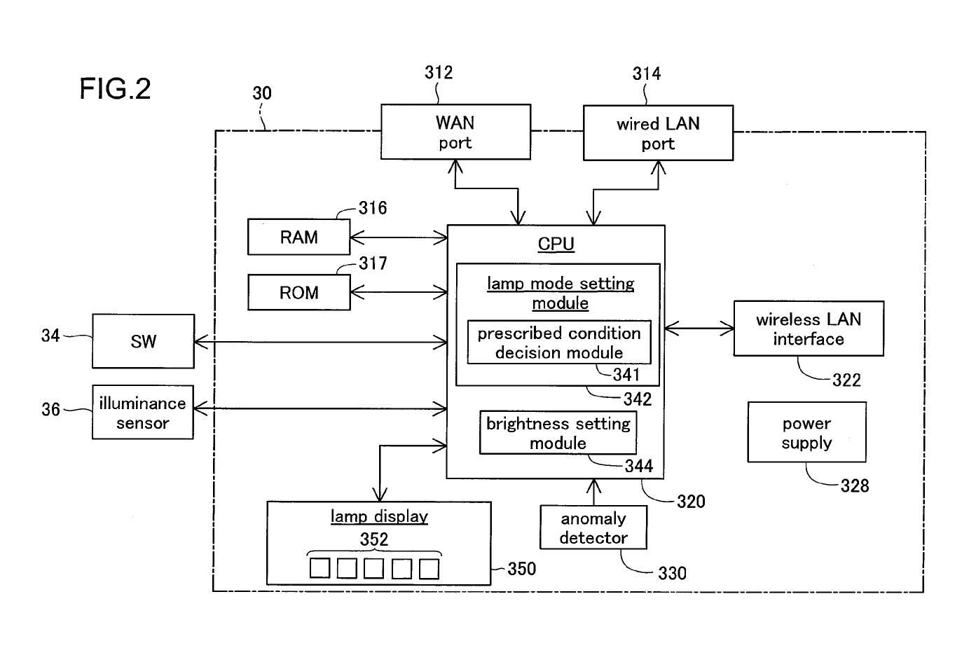

FIG. 2 is a block diagram depicting the internal configuration of a network device. The network device 30 comprises a power supply 328, a CPU 320, a WAN port 312 serving as a WAN interface, a wired LAN port 314 serving as a wired LAN interface, a wireless LAN interface 322, a RAM 316, a ROM 317, an anomaly detector 330, and a lamp display 350.

The power supply 328 supplies power to the network device 30 as a whole. The CPU 320 controls the components that are connected thereto via the bus. The CPU 320 functions primarily as a lamp mode setting module 342 for setting the mode of the lamp display 350, and as a brightness setting module 344 for setting the brightness of the display lamps 352. The lamp mode setting module 342 also includes therein a prescribed condition decision module 341. The prescribed condition decision module 341 is discussed in detail later. The modem 10 is connected to the WAN port 312 by the cable CAL while the computer 24 and the television 26 are connected to the wired LAN port 314 by the cables CA2, CA3. The wired LAN port 314 is a wired network interface compliant with the IEEE 802.3 standard for wired network connections. The wireless LAN interface 322 is a wireless network interface compliant with a standard such as IEEE 802.11a, b, g, or n. The ROM 317 stores computer programs for carrying out communications with the terminals 21, 22, 24, 26; various programs relating to connection to the Internet IN; programs for setting the lamp mode, and so on. The computer programs for carrying out communications with the terminals 21, 22, 24, 26 include a program that relates to registering MAC addresses of the wireless LAN adapters of the terminals 21, 22 that communicate wirelessly (MAC registration program).

The anomaly detector 330 detects the occurrence of network anomalies, and the occurrence of anomalies in the network device 30. A “network anomaly” refers to an instance in which, for example, a problem has occurred with communications on the wired LAN or the wireless LAN; an instance in which the network was improperly accessed from the outside; or an instance of an outside attack on the network. In other words, a “network anomaly” means an instance in which conditions on the network are different from the network conditions expected of normal operation of the network. The severity of network conditions to be designated as a network anomaly may be established appropriately by the user. A “network device 30 anomaly” refers to an instance in which an internal component of the network device 30, such as the RAM 316 or ROM 317, incurs a problem. In other words, it refers to an operating condition different from the previously expected operating condition of the network device 30.

The lamp display 350 has a plurality of display lamps 352. The user can observe the display lamps 352 through the display 32 (FIG. 1) of the network device 30. With the network device 30 powered, the lamp display 350 has a “display mode” in which the display lamps 352 can light up independently, and a “non-display mode” in which the display lamps 352 do not light up. The display lamps 352 includes lamps that light up continuously to inform the user of the network operational status; and lamps that flash by repeatedly turning on and off at prescribed intervals to inform the user of the network operational status. As specific examples of the display lamps 352, there may be provided a lamp that lights up when power of the network device 30 is ON; a lamp that lights up when wireless communication is enabled; a lamp that flashes during wireless communication; a lamp that lights up when router mode is enabled; a lamp that lights up or flashes when an anomaly occurs; a lamp that flashes during the security setting of the network device 30; lamps that light up when the cables CA1, CA2, CA3 are properly connected to the wired LAN port and WAN port respectively, and that flash during communications. The types of the display lamps 352 actually provided may be selected based on the need for the user to be informed of particular conditions.

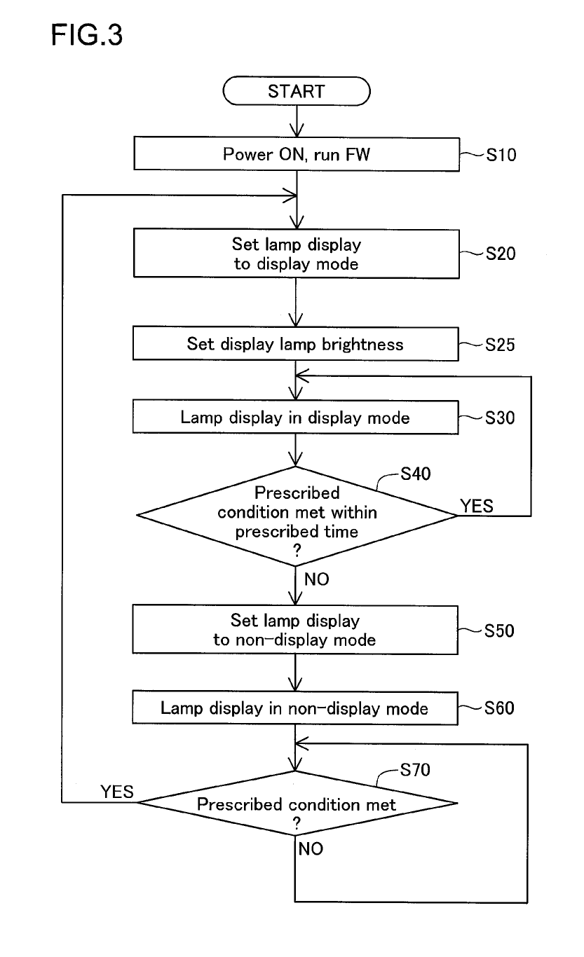

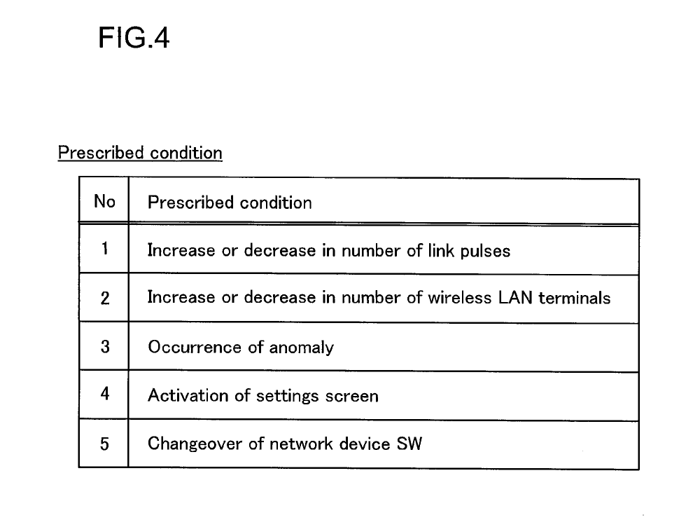

Operation setup of the lamp display 350 of the first embodiment will be described using FIGS. 3 and 4. FIG. 3 is a flowchart depicting operation setup of the lamp display 350 of the first embodiment. FIG. 4 is a table listing prescribed conditions for the prescribed condition decision module 341 to carry out decisions. As depicted in FIG. 3, when the user turns ON the network device 30, the firmware (FW) of the network device 30 starts up (Step S10). Next, the lamp mode setting module 342 sets the lamp display 350 to the display mode (Step S20). Next, the brightness setting module 344 sets the brightness of the display lamps 352 (Step S25). Subsequent to Step S20 and Step S25, the lamp display 350 enters into the display mode (Step S30). With the lamp display 350 in the display mode, the display lamps 352 light up/flash to inform the user of the network operational status. The brightness setting module 344 decides whether the illuminance sensed by the illuminance sensor 36 lies in a high illuminance range, or in a low illuminance range that is lower than the high illuminance range; and when determined to lie in the high illuminance range, sets the brightness of the display lamps 352 to high brightness, or when determined to lie in the low illuminance range, sets the brightness of the display lamps 352 to low brightness that is lower than the high brightness. Illuminance ranges for the high illuminance range and for the low illuminance range, and brightness values for high brightness and for low brightness, are stored beforehand in the ROM 317. Illuminance ranges for the high illuminance range and for the low illuminance range, and brightness values for high brightness and for low brightness, may be modified or set appropriately by the user.

Next, the prescribed condition decision module 341 decides whether a prescribed condition is met within a prescribed time interval (Step S40). Specifically, the prescribed condition decision module 341, through operation in accordance with a program stored in the ROM 317, decides whether at least one of Conditions No. 1 to No. 5 shown in FIG. 4 is met. If at least one of the Conditions No. 1 to No. 5 shown in FIG. 4 is met, the prescribed condition decision module 341 decides that a prescribed condition is met. On the other hand, when none of the Conditions No. 1 to No. 5 is met, the prescribed condition decision module 341 decides that no prescribed condition is met. The Conditions No. 1 to No. 5 are discussed in detail later.

If the prescribed condition is met within a prescribed time interval, the lamp display 350 maintains the display mode, and the display lamps 352 light up/flash according to network operational status. On the other hand, when no prescribed condition is met within a prescribed time interval, the lamp mode setting module 342 sets the lamp display 350 to the non-display mode (Step S50), and the lamp display 350 enters the non-display mode (Step S60). Once the lamp display 350 enters the non-display mode, the display lamps 352 go off. Here, the “prescribed time interval” is a time interval arbitrarily set beforehand, and the duration thereof can be modified or set appropriately by the user. In the present embodiment, the prescribed time interval is set to 10 minutes. If the lamp display 350 enters the display mode from the non-display mode, or when it enters the display mode due to the power going from OFF to ON, the count of the prescribed time interval preferably begins when the lamp display 350 enters the display mode; or when the lamp display 350 is currently in the display mode, it preferably begins as the lamp display 350 receives from the lamp mode setting module 342 the notification that a prescribed condition is met in Step S40.

With the lamp display 350 in the non-display mode, the lamp mode setting module 342 decides whether the prescribed condition of Step S40 is met (Step S70). If the prescribed condition is met, the lamp mode setting module 342 sets the lamp display 350 to the display mode (Step S20), and the lamp display 350 enters the display mode (Step S30). If no prescribed condition is met (Step S70: NO), a decision is again made as to whether a prescribed condition is met or not.

As shown in FIG. 4, the conditions regarding which the prescribed condition decision module 341 makes a decision are Conditions No. 1 to No. 5. Condition No. 1 is “increase or decrease in number of link pulses”. This refers to whether there was an increase or decrease in number of link pulses sent from the terminals 24, 26 (FIG. 1) on the wired LAN to the network device 30 via the cables CA2, CA3. More specifically, when for example the television 26 is newly connected to the wired LAN port 314 using the cable CA2, and the network device 30 detects link pulses being sent from the television 26, Condition No. 1 corresponding to an “increase” of link pulses is satisfied. If power to the television 26 goes from ON to OFF, or when the cable CA2 connecting the television 26 and the network device 30 is unplugged from the LAN port 314, Condition No. 1 corresponding to a “decrease” of link pulses is satisfied. However, it is preferable that Condition No. 1 exclude instances where, with only a single terminal transmitting link pulses to the network device 30, and with the terminals 21, 22 that communicate wirelessly turned off, the terminal that is transmitting link pulses ceases to transmit link pulses. The reason is that in such an instance it is conceivable that the user intends to suspend or discontinue the use of the LAN, and thus there is no need to inform the user of the increase or decrease in the number of the link pulses through lighting/flashing of the display lamps 352.

Condition No. 2 is “increase or decrease in number of wireless LAN terminals”. This refers to whether there was an increase or decrease in number of MAC addresses of wireless LAN adapters currently registered with the network device 30. More specifically, when for example a new LAN adapter is connected to the network device 30, the MAC address of the new LAN adapter is registered with the network device 30, and the condition of “an increase in the number of wireless LAN terminals” applies, so Condition No. 2 is met. If a LAN adapter is disconnected from the network device 30, its registered MAC address is deleted, and the condition of “a decrease in the number of wireless LAN terminals” applies, so Condition No. 2 is met.

Condition No. 3 is “occurrence of anomaly”. This refers to detection of an anomaly by the anomaly detector 330 (FIG. 2). Condition No. 4 is “activation of settings screen”. This represents the user's activation of a settings screen on the display of a terminal 21, 22, 24, 26 by a terminal 21, 22, 24, 26 on the LAN, for the purpose of configuring various settings for the network or for the network device 30. Examples of settings for the network or network device 30 include encryption key settings, network mode settings, wireless LAN communication standard (IEEE 802.11a, b, g, n) settings, a setting to restore the network device 30 to its initial state, and so on. Condition No. 5 is “changeover of network device switch (SW)”. This refers to the changeover of the switch 34 for changing the various settings of the network device 30. Prescribed conditions are not limited to those described above, but any other similar conditions may be established as well. In other words, conditions necessitating informing the user of network operational status through lighting/flashing of the display lamps 352 may be established appropriately.

As described previously, with the lamp display 350 in the display mode, when no prescribed condition is met within a prescribed time interval, the lamp display 350 enters the non-display mode (Step S40 to Step S60), whereby power consumption associated with lighting/flashing of the lamps can be reduced. Also, because the lamp display 350 enters the non-display mode, the annoying distraction of the user can be minimized Meanwhile, with the lamp display 350 in the non-display mode, when a prescribed condition is met, the lamp display 350 switches to the display mode (Step S70, Step S20 to Step S30), so the user can reliably be informed of the operational status of the network device 30 through lighting/flashing of the display lamps 352. By specifying beforehand conditions requiring the user to take note of the display lamps 352, it is possible for the user to ascertain connection conditions and communication conditions on the LAN through lighting/flashing of the display lamps 352. Further, with the lamp display 350 in the display mode, the brightness of the display lamps 352 is set according to ambient illuminance, thereby affording further reduction in power consumption associated with lighting/flashing of the display lamps 352. Moreover, when ambient illuminance lies in a high illuminance range, the brightness of the display lamps 352 is set to a high brightness level, so even when the environment (room) where the network device 30 is placed is bright, the user can be made aware that the display lamps 352 are lighting/flashing. The user can thereby reliably ascertain LAN connection conditions and communication conditions through lighting/flashing of the display lamps 352.

### B. Second Embodiment

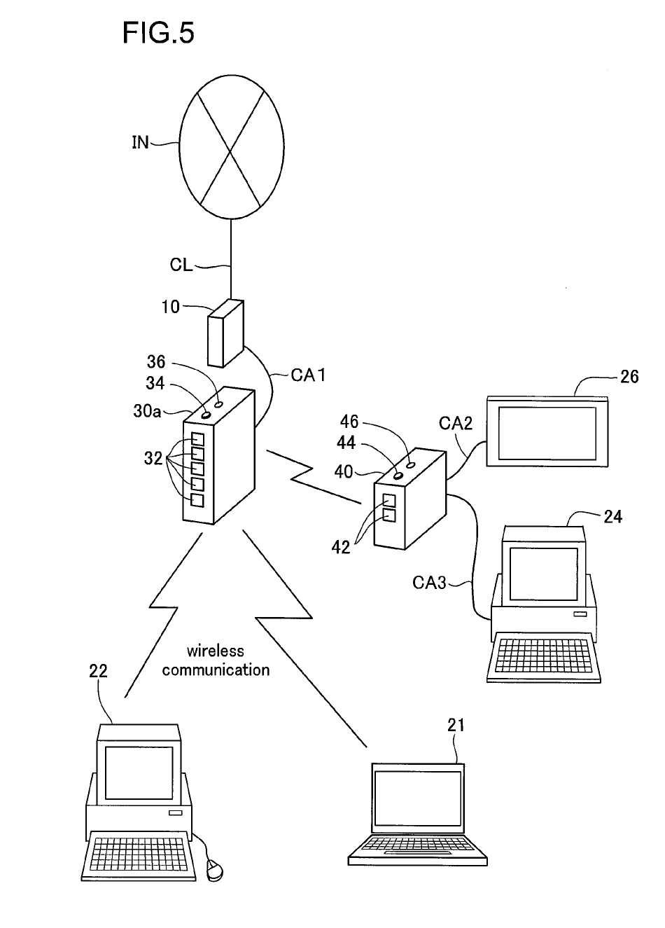

FIG. 5 is an illustration depicting a mode of a network employing network devices 30a, 40 according to a second embodiment of the present invention. This second embodiment differs from the first embodiment in that a separate network device 40 (hereinafter also termed “wireless LAN terminal 40”) is provided in addition to the network device 30a (hereinafter also termed “wireless LAN base station 30a”). Except the addition, the structure of the second embodiment is the same as that of the first embodiment. Therefore, like components are designated by like reference symbols and the description thereof is omitted to avoid repetition. The wireless LAN base station 30a has the same configuration as the network device 30 of the first embodiment; and moreover the operation of the lamp display of the wireless LAN base station 30a is set up in the same way as in the network device 30 of the first embodiment (FIGS. 3, 4). As in the first embodiment, the lamp display of the wireless LAN terminal 40 has a display mode and a non-display mode. The wireless LAN terminal 40 communicates wirelessly with the wireless LAN base station 30a. The wireless LAN terminal 40 has a wired LAN ports, and is so designed that terminals having wired LAN ports (e.g. the television 26 and the computer 24) can be used in a wireless LAN environment by hooking up the terminals 24, 26 with cables CA2, CA3. This sort of wireless LAN terminal 40 is also termed an “Ethernet converter”.

The wireless LAN terminal 40 is equipped with a plurality of displays 42 that house a plurality of display lamps which are visible from the outside when lighting/flashing; a switch (SW) 44 for changing the various settings of the wireless LAN terminal 40; an illuminance sensor 46 for sensing ambient illuminace around the wireless LAN terminal 40; and several connection ports (not shown) for connecting the cables CA2, CA3.

Through independent lighting/flashing of these display lamps 42, the user may be informed of the condition of connection to the network, conditions of the network, and condition of wireless LAN terminal 40, as well as the changes in these conditions. As specific examples, the display lamps 42 may light/flash to inform the user of anomalies occurring on the network; anomalies occurring in the wireless LAN terminal 40; the presence of a settings mode for making security settings such as wireless LAN encryption method or encryption key etc.; whether the wireless LAN terminal is active; and whether the cables CA2, CA3 are properly connected to the wired LAN port.

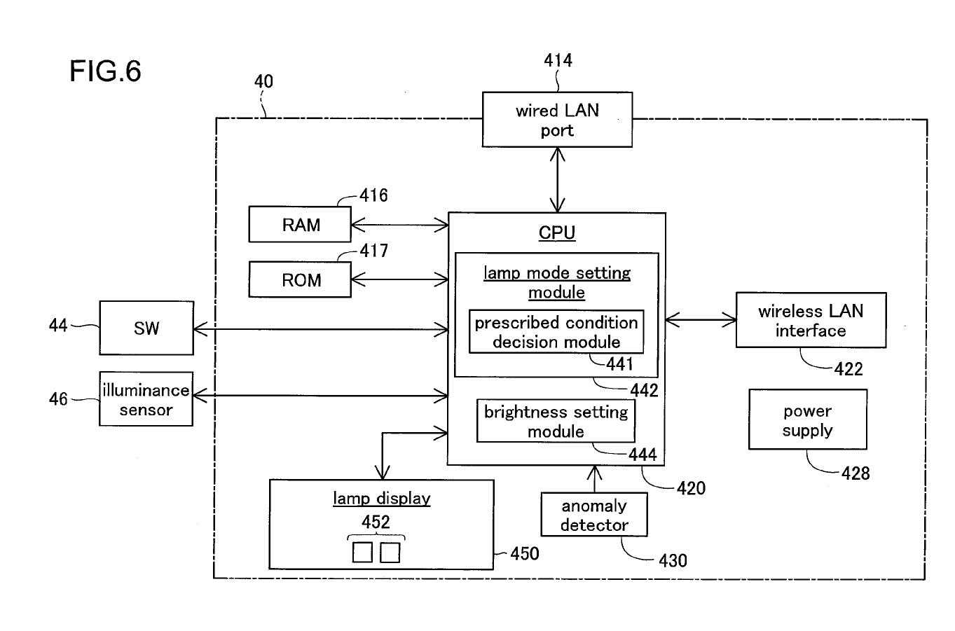

FIG. 6 is a block diagram depicting the internal configuration of the wireless LAN terminal 40. The hardware configuration differs from that of the network device 30 of the first embodiment in that that no WAN port is provided as a WAN interface; and also in the type of display lamps 452 provided. Specifically, the display lamps 452 may be composed of, for example, a lamp that lights up when the wireless LAN terminal is powered (also termed the “first lamp”), a lamp that lights up or flashes when an anomaly occurs (also termed the “second lamp”), or a lamp that flashes when security settings of the wireless LAN terminal 40 are entered. In the present embodiment, the first lamp and the second lamp are the same as each other. The types of display lamps 452 housed inside the wireless LAN terminal 40 may be selected based on the need to inform the user of certain conditions. The same part names are employed in reference to the internal configuration of the wireless LAN terminal of the present embodiment as for the corresponding internal configuration of the network device 30 of the first embodiment. However, the reference symbols assigned to the corresponding parts have been changed.

The operation of the lamp display 450 of the wireless LAN terminal 40 is set up through Steps S10 to S70 comparable to those of the first embodiment. During setup of operation of the lamp display 450, the prescribed condition (FIG. 4) regarding which the prescribed condition decision module 441 makes decisions in Step S40 is established in consideration of the functions of the wireless LAN terminal 40. For example, of the prescribed condition shown in FIG. 4, Condition No. 2 may be omitted. Meanwhile, Condition No. 1 and Conditions Nos. 3 to 5 may be established in the same way as in the first embodiment for example. With regard to Condition No. 1, when for example only a single terminal is transmitting link pulses to the wireless LAN terminal 40, and the transmission of link pulses from that terminal subsequently ceases (i.e. when the wireless LAN terminal 40 no longer detects any link pulses), this constitutes a decrease in link pulses. However, in consideration of the functions of the wireless LAN terminal 40, it is preferable that Condition No. 1 exclude such an instance. The reason is that in such an instance it is conceivable that the user intends to suspend or discontinue the use of the wireless LAN terminal 40, and thus there is no need to inform the user of the increase or decrease in number of link pulses through lighting/flashing of the display lamps 452.

As mentioned above, the operations of the lamp display of the wireless LAN base station 30a and the lamp display 450 of the wireless LAN terminal 40 are set up through Steps S10 to S70 comparable to those of the first embodiment, and thus power consumption associated with lighting/flashing of the display lamps can be reduced as in the first embodiment. Moreover, when a prescribed condition requiring the user to take note of the display lamps is met, the lamp display 450 enters the display mode, thus enabling the user to ascertain connection conditions and communication conditions on the LAN through lighting/flashing of the display lamps. Additionally, annoying distraction to the user can be avoided by causing the lamp display 450 to enter the non-display mode when the prescribed condition is not satisfied.

### C. Modified Embodiments

Of the constituent elements set forth in the embodiments hereinabove, elements other than those expressly claimed in independent claims are supplemental elements and may be dispensed with as appropriate. The invention is not limited to the particular embodiments set forth hereinabove, but may be reduced to practice in various other modes, such as in, for example, the following modifications while residing within the scope and spirit thereof.

### C-1. Modified Embodiment 1

While the network devices 30, 30a, 40 were exemplified as a broadband router or an Ethernet converter in the preceding embodiments, the embodiments of the invention is not limited to those examples, but the operation mode of the lamp display of the present invention may be implemented in any of various network devices equipped with lamps that are visible from the outside. For example, the operation mode of the lamp display according to the present invention may be implemented in network devices that lack router function or hub function, or network devices that have router function only but lack wireless LAN access point function or hub function. The network devices 30, 30a were not equipped with a modem, but they may be equipped with a modem.

### C-2. Modified Embodiment 2

In the preceding embodiments, the network devices 30, 30a, 40 were equipped with the illuminance sensors 36, 46, but it is not essential to provide the illuminance sensors 36, 46. If the illuminance sensors 36, 46 are eliminated, the associated brightness setting modules 344, 444 may be eliminated as well, with the result that Step S25 for the operation setup of the lamp display 350, 450 is eliminated. Even with this arrangement, because the lamp display 350, 450 switches between the display mode and the non-display mode according to whether the lamp display 350, 450a satisfy the prescribed condition, power consumption associated with lighting/flashing of the display lamps 352, 452 can be reduced as compared with the case that the display lamps 352, 452 are lighting/flashing continuously. With the lamp display 350, 450 in the display mode, the user is able to ascertain the connection conditions and communication conditions on the LAN through lighting/flashing of the display lamps 352, 452. Additionally, annoying distraction to the user can be suppressed to a great extent with the lamp display 350, 450 in the non-display.

### C-3. Modified Embodiment 3

No particular limitation is imposed on the prescribed condition employed in the preceding embodiments. For example, any of the prescribed conditions, Conditions No. 1 through No. 5, may be omitted, or new conditions may be established by way of the prescribed condition. In other words, in consideration of the functions of the network device 30, 30a, 40 and the network operational status that must be informed the user through lighting/flashing of the lamps, certain conditions that are likely to require the user to take note of the lamps can be included in the prescribed condition. Some of the features implemented through hardware in the preceding embodiments may be replaced by software (computer programs), and conversely some of the features implemented through software may be replaced by hardware.

### C-4. Modified Embodiment 4

No particular limitation is imposed on the prescribed condition employed in the preceding embodiments. For example, the prescribed condition may include in part a condition that the user directly performed a prescribed operation on the network device 30, 30a, 40. The prescribed condition may also include in part a condition that the user performed a prescribed operation on the network device 30, 30a, 40 through another device (e.g. a terminal, the network device or the remote controller of the terminal).

### C-5. Modified Embodiment 5

While the preceding embodiments illustrated examples in which lamp display operation setup was carried out for all of the display lamps 352, 452 of the network device 30, 30a, 40, all the display lamps 352, 452 are not intended to be subjected to the lamp display operation setup according to the present invention. For example, when the display lamps include both display lamps that are visible from the front side of the network device and display lamps that are visible from the back side, the lamp display operation setup according to the present invention may be applied for the display lamps of the front side only, or for the display lamps of the back side only. The lamp display operation setup according to the present invention may be applied for at least one of the lamps that are visible from the outside. In other words, lamps that are highly necessary for informing the user may remain lit continuously. Specifically, the lamp indicating ON/OFF status of the network device 30, 30a, 40 may be located in place other than in the lamp display 352, 452 and may remain lit continuously when the power is ON. By applying the lamp display operation setup according to the present invention for at least one of lamps provided inside the network device 30, 30a, 40 and visible from the outside, power consumption associated with lighting/flashing of the lamp or lamps can be reduced, as compared to when the operation setup according to the present invention were not implemented. Annoying distraction to the user can be minimized as well.

### C-6. Modified Embodiment 6

In the preceding embodiments, LEDs were employed as the display lamps 352, 452 and the back panel lamps, but other types of lamps may be used. For example, LCD (Liquid Crystal Display) or EL (Electroluminescence) lamps may be used.

### C-7. Modified Embodiment 7

In the preceding embodiments, during operation setup of the lamp display 350, 450, setting of the brightness of the display lamps 352, 452 (Step S25) was carried out between Step S20 and Step S30, but no limitation thereto is imposed, and Step S25 can be carried out always when the lamp display 350, 450 is in the display mode. For example, with the lamp display 350, 450 in the display mode, when the brightness setting module 344 senses the change of the ambient illuminance from the high illuminance range to the low illuminance range, it may then switch the brightness of the display lamps 352, 452 from high to low brightness level. By carrying out Step S25 always during the display mode as described above, it is possible to attain further reductions in power consumption associated with lighting/flashing of the display lamps 352, 452 when the lamp display 350, 450 is in the display mode.

While the present invention has been described with reference to exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including fewer elements or only a single element, are also within the spirit and scope of the invention.

What is claimed is:

1. A network device adapted to connect an electronic device to a network, comprising:
a lamp display that includes a lamp visible from the outside, and that has a display mode in which the lamp may light up when the network device is powered on, and a non-display mode in which the lamp does not light up when the network device is powered on; and
a lamp mode setting module that selects one of the display mode and the non-display mode,
wherein when a prescribed condition requiring the user to take note of the lamp is not met within a prescribed time interval in the display mode, the lamp mode setting module sets the lamp display to the non-display mode, and
when the prescribed condition is met in the non-display mode, the lamp mode setting module sets the lamp display to the display mode.

2. The network device according to claim 1,
wherein the prescribed condition includes at least in part a condition that the user performed a prescribed operation on the network device.

3. The network device according to claim 2,
wherein the prescribed operation is that the user activates a settings screen of the network device.

4. The network device according to claim 2, further comprising:
a switch to change various settings of the network device,
wherein the prescribed operation is for the user to change over the switch.

5. The network device according to claim 1,
wherein the prescribed condition includes at least in part a condition that connection status of the electronic device to the network has been changed.

6. The network device according to claim 5,
wherein the change in connection status of the electronic device to the network is an increase or decrease of link pulses received by the network device.

7. The network device according to claim 1, further comprising:
an anomaly detector to detect an anomaly in the network or the network device,
wherein the prescribed condition includes at least in part a condition that the anomaly detector has detected the anomaly.

8. The network device according to claim 1, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.

9. The network device according to claim 2, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.

10. The network device according to claim 3, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.

11. The network device according to claim 4, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.

12. The network device according to claim 5, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.

13. The network device according to claim 6, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.

14. The network device according to claim 7, further comprising:
an illuminance sensor to sense ambient illuminance around the network device; and
a brightness setting module to set brightness of the lamp,
wherein in a first instance in which the illuminance sensor senses high illuminance, the brightness setting module establishes a high brightness level when the lamp lights up, and
wherein in a second instance in which the illuminance sensor senses illuminance lower than in the first instance, the brightness setting module establishes a lower brightness level lower than in the first instance when the lamp lights up.
